(19) United States
(12) Patent Application Publication
(10) Pub. No.: US 2024/0308268 A1
(43) Pub. Date: Sep. 19, 2024

(54) WHEEL ASSEMBLY

(71) Applicants: HYUNDAI MOTOR COMPANY, Seoul (KR); Kia Corporation, Seoul (KR)

(72) Inventors: Ji Woo HA, Suwon-si (KR); Hun Keon KO, Anyang-si (KR); Kyung Min KIM, Seoul (KR); Hyeon Sik SHIN, Hwaseong-si (KR); Tae Yu KIM, Suwon-si (KR)

(21) Appl. No.: 18/484,029

(22) Filed: Oct. 10, 2023

(30) Foreign Application Priority Data
Mar. 13, 2023 (KR) 10-2023-0032641

(51) Int. Cl. B60B 19/00; B60B 27/00; B60K 17/00

(52) U.S. Cl. CPC B60B 19/00; B60B 27/0015; B60K 17/00

(57) ABSTRACT

Disclosed is a wheel assembly including a main rotation part that is to be rotated about a first rotation axis, a power transmitting part that receives power from the main rotation part, and a variable rotation part that receives a rotational force from the power transmitting part to be rotated about a second rotation axis when the main rotation part is rotated, and to be moved relative to the main rotation part such that the first rotation axis and the second rotation axis overlap each other or are spaced apart from each other.

### CROSS-REFERENCE TO RELATED APPLICATION

This application claims the benefit of priority to Korean Patent Application No. 10-2023-0032641, filed in the Korean Intellectual Property Office on Mar. 13, 2023, the entire contents of which are incorporated herein by reference.

### TECHNICAL FIELD

The present disclosure relates to a wheel assembly.

### BACKGROUND

Robots can largely include “leg” type robots in a form, in which it may walk by using leg-shaped structures, and “wheel” type robots in a form, in which it may travel by using wheels. A movement speed of a leg type robot may be low and energy use efficiency thereof may be degraded on a flat ground surface. Furthermore, a travel performance of a wheel type robot may be degraded in certain environments, such as stairs or rough terrain. In recent years, to supplement disadvantages of the leg type robots and the wheel type robots, moving bodies provided with a wheel assembly in a form, in which advantages of the two types of robots are combined, have been developed.

A wheel assembly provided in a conventional moving body includes a main rotation body that is rotated about a main rotation axis, and a variable rotation body that receives power from the main rotation body to be moved relatively to the main rotation body while being rotated about a variable rotation axis. For example, the variable rotation body may be moved relatively to the main rotation body on a specific movement allowable area such that the variable rotation axis becomes farther from or closer to the main rotation axis.

In some cases, the variable rotation axis and the main rotation axis of the conventional wheel assembly do not overlap each other and may be laid only in a state, in which they are spaced apart from each other. In this way, when the variable rotation axis and the main rotation axis fail to overlap each other, a movement range of the variable rotation body is restricted in an area around the main rotation axis. When the movement range of the variable rotation body is restricted in this way, the wheel assembly cannot implement various postures as the posture, in which the wheel assembly may be laid, is restricted.

### SUMMARY

An aspect of the present disclosure provides a wheel assembly that may implement various postures by securing a sufficient movement range of a variable rotation part.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a wheel assembly includes a main rotation part that is rotated about a first rotation axis, a power transmitting part that receives power from the main rotation part, and a variable rotation part that receives a rotational force from the power transmitting part to be rotated about a second rotation axis when the main rotation part is rotated, and to be moved relatively to the main rotation part such that the first rotation axis and the second rotation axis overlap each other or are spaced apart from each other.

Furthermore, the power transmitting part may include a first link part, one end of which is connected to the main rotation part to be rotatable, and that receives the power of the main rotation part when the main rotation part is rotated, and a first medium rotation part connected to an opposite end of the first link part to be rotatable, that receives the power from the first link part, and that transmits the received power to the variable rotation part such that the variable rotation part is rotated.

Furthermore, the power transmitting part may further include a second medium rotation part that receives the power from the first medium rotation part, and a second link part, one end of which is connected to the second medium rotation part to be rotatable, and an opposite end of which is connected to the variable rotation part to be rotatable, and wherein the second link part may receive the power of the second medium rotation part, and transmits the received power to the variable rotation part such that the variable rotation part is rotated.

Furthermore, when the wheel assembly is viewed in a direction that is perpendicular to the first rotation axis, the main rotation part may be disposed between the first medium rotation part and the second medium rotation part.

Furthermore, the wheel assembly may further include a spoke, an inner end of which is connected to the variable rotation part to be rotatable and an outer end of which contacts a ground surface.

Furthermore, the main rotation part may include a main rotation body, and a rotation support part connected to a periphery of the main rotation body to be rotatable to support the spoke, and the spoke may be configured such that the spoke is translated with respect to the rotation support part when the variable rotation part is moved relatively to the main rotation part, and an inner end thereof is connected to a periphery of the variable rotation part to be rotatable.

Furthermore, an outer end of the spoke may be translated to become farther from the rotation support part when being moved relatively to the main rotation part such that the variable rotation part becomes closer to the rotation support part, and be translated to become closer to the rotation support part when being moved relatively to the main rotation part such that the variable rotation part becomes farther from the rotation support part.

Furthermore, a plurality of rotation support parts may be provided to be arranged to be spaced apart from each other along a rotational direction of the main rotation part, and a plurality of spokes may be provided to correspond to the rotation support parts, respectively.

Furthermore, the spoke may be inserted into the rotation support part, and a guide hole that guides translations of the spoke with respect to the rotation support part is formed therein.

Furthermore, when, among the plurality of rotation support parts, adjacent arbitrary two rotation support parts are defined as a first rotation support part and a second rotation support part, respectively, and when the variable rotation part is moved relatively to the main rotation part toward an area of a periphery of the main rotation body, which is formed between the first rotation support part and the second rotation support part, the first rotation support part and the second rotation support part may be rotated with respect to the main rotation body such that an angle defined by an imaginary line that extends along a guide hole of the first rotation support part and an imaginary line that extends along a guide hole of the second rotation support part becomes larger.

Furthermore, the wheel assembly may further include a first driving part that rotates the main rotation part, and a second driving part that moves the variable rotation part relatively to the main rotation part, and the first driving part and the second driving part may be driven independently.

Furthermore, the first driving part may include a main rotary motor that provides a pulley rotation axis that is spaced apart from the first rotation axis, a driving pulley being rotated about the pulley rotation axis when the main rotary motor is driven, and a driven pulley that receives a rotational force from the driving pulley to be rotated about the first rotation axis together with the main rotation part when the driving pulley is rotated.

Furthermore, the pulley rotation axis may be spaced apart from the second rotation axis.

Furthermore, the second driving part may include a fixed driving part including a fixed driving arm, one end of which is rotated about a fixed center of rotation, of which a relative location with respect to the first rotation axis is fixed, and a variable driving part including a variable driving arm, one end of which is connected to the fixed driving arm and an opposite end of which is connected to the variable rotation part, and that is rotated about a variable center of rotation that passes through the fixed driving arm and is spaced apart from the fixed center of rotation.

Furthermore, the second rotation axis may pass through the opposite end of the variable driving part and may extend along a direction that is parallel to the fixed center of rotation, and the second rotation axis and the fixed center of rotation may be laid in any one of an overlapping state, in which they overlap each other, and a spacing state, in which they are spaced apart from each other.

Furthermore, the first rotation axis, the second rotation axis, and the fixed center of rotation may overlap each other to define one imaginary line.

Furthermore, the fixed driving part may further include a fixed motor that provides the fixed center of rotation, and connected to the fixed driving arm to rotate one end of the fixed driving arm about the fixed center of rotation, and the variable driving part may further include a variable motor that provides the variable center of rotation, connected to the one end of the fixed driving arm, and connected to the variable driving arm to rotate an opposite end of the variable driving arm about the variable center of rotation.

Furthermore, the fixed motor and the variable motor may be driven independently.

Furthermore, the variable rotation part may be moved relatively to the main rotation part in a movement allowable area that is an area that crosses the first rotation axis, and the movement allowable area may be surrounded by an imaginary circle, a center of which is a point, at which the movement allowable area and the first rotation axis cross each other and a radius of which is a sum of a first driving distance that is a spacing distance between the fixed center of rotation and the variable center of rotation and a second driving distance that is a spacing distance between the second rotation axis and the variable center of rotation.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of an example moving body according to an implementation of the present disclosure;

FIG. 2 is an exploded perspective view of an example wheel assembly according to an implementation of the present disclosure;

FIG. 3 is a cross-sectional view of the wheel assembly, taken along A-A′ of FIG. 1;

FIG. 4 is a cross-sectional perspective view of the wheel assembly, taken along B-B′ of FIG. 3;

FIG. 5 is a cross-sectional perspective view of the wheel assembly, taken along C-C′ of FIG. 3;

FIG. 6 is a cross-sectional perspective view of the wheel assembly, taken along D-D′ of FIG. 3;

FIG. 7 is a cross-sectional perspective view of the wheel assembly, taken along E-E′ of FIG. 3;

FIG. 8 is a perspective view of an example power transmitting part and a driving part according to an implementation of the present disclosure;

FIG. 9 is a side view of an example moving body in a state, in which a plurality of spokes are positioned in a first posture, according to an implementation of the present disclosure;

FIG. 10 is a side view of an example moving body in a state, in which a plurality of spokes are positioned in a second posture, according to an implementation of the present disclosure;

FIG. 11 is a flowchart schematically illustrating an example method for controlling a wheel assembly according to an implementation of the present disclosure; and

FIG. 12 is a flowchart schematically illustrating an example method for controlling a wheel assembly according to another implementation of the present disclosure.

### DETAILED DESCRIPTION

Hereinafter, some implementations of the present disclosure will be described in detail with reference to the exemplary drawings. Throughout the specification, it is noted that the same or like reference numerals denote the same or like components even though they are provided in different drawings. Further, in the following description of the present disclosure, a detailed description of known functions and configurations incorporated herein will be omitted when it may make the subject matter of the present disclosure rather unclear.

Hereinafter, a moving body 1 according to an implementation of the present disclosure will be described with reference to the drawings.

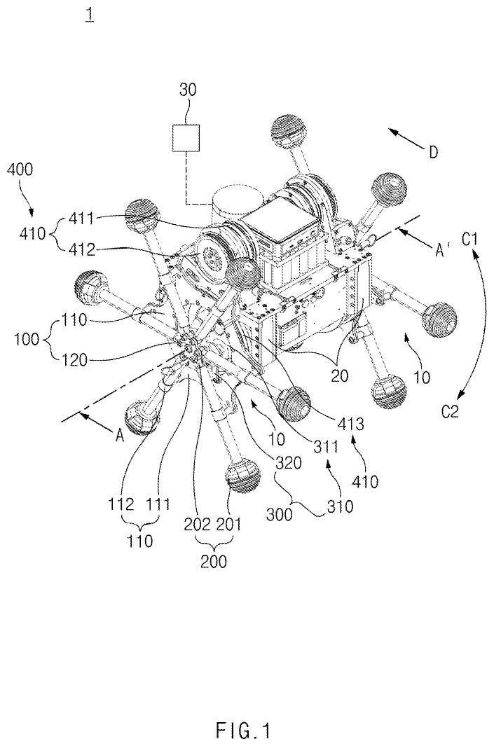

Referring to FIG. 1, the moving body 1 according to the present disclosure may travel on a ground surface. A posture of the moving body 1 may be changed according to a state of a ground surface, and the moving body 1 may effectively pass on a ground surface, such as stairs, which has a step. Furthermore, the moving body 1 may implement a motion that simulates a walk of a person. The moving body 1 may include a wheel assembly 10, a frame 20, and a controller 30.

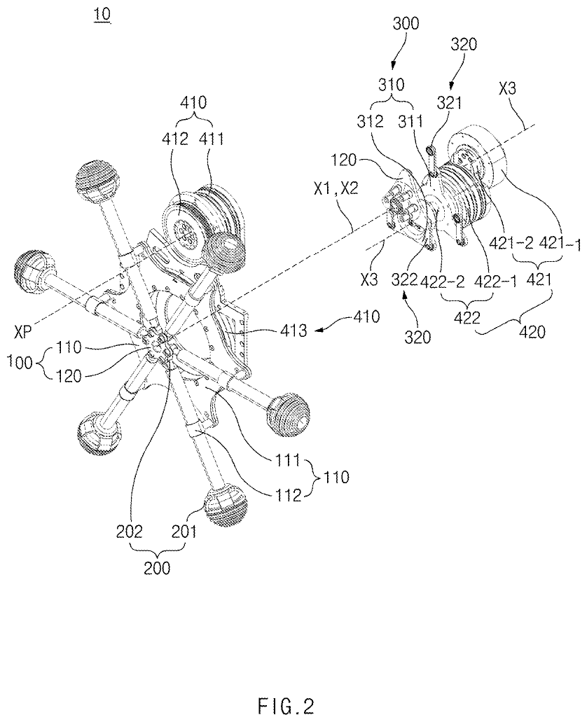

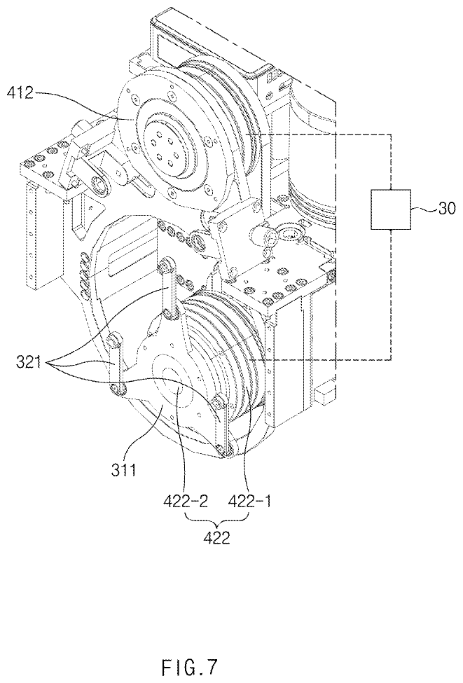

Referring further to FIGS. 2 to 10, the wheel assembly 10 may travel toward a targeted location together with the frame 20 while being supported by the frame 20. A plurality of wheel assemblies 10 may be provided. The plurality of wheel assemblies 10 may be disposed on opposite sides of the frame 20, respectively. For example, the plurality of wheel assemblies 10 may be disposed to face each other. The wheel assembly 10 may include a rotation part 100, a spoke 200, a power transmitting part 300, and a driving part 400.

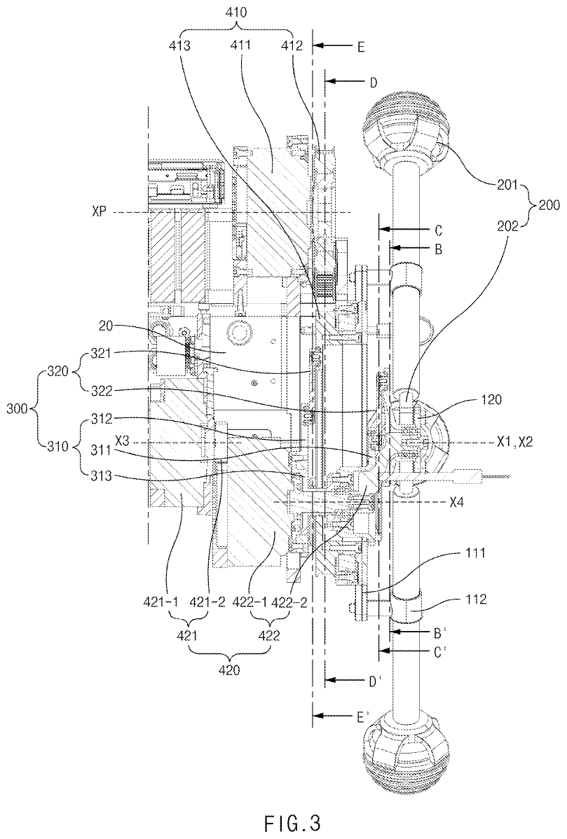

Referring back to FIG. 3, the rotation part 100 may be rotated with respect to the frame 20. Furthermore, the rotation part 100 may transmit power to the spoke 200. The rotation part 100 may include a main rotation part 110 and a variable rotation part 120.

The main rotation part 110 may be rotated about a first rotation axis X1. A relative location of the first rotation axis X1 to the frame 20 may be fixed. The first rotation axis X1 may be defined as an imaginary line that passes through a center of the main rotation part 110 and extends along an axial direction thereof. The axial direction may be defined as a direction that is perpendicular to a travel direction “D” and an upward/downward direction. The travel direction “D” may be defined as a direction, in which the moving body 1 is moved with respect to the ground surface. The main rotation part 110 may include a main rotation body 111 and a rotation support part 112.

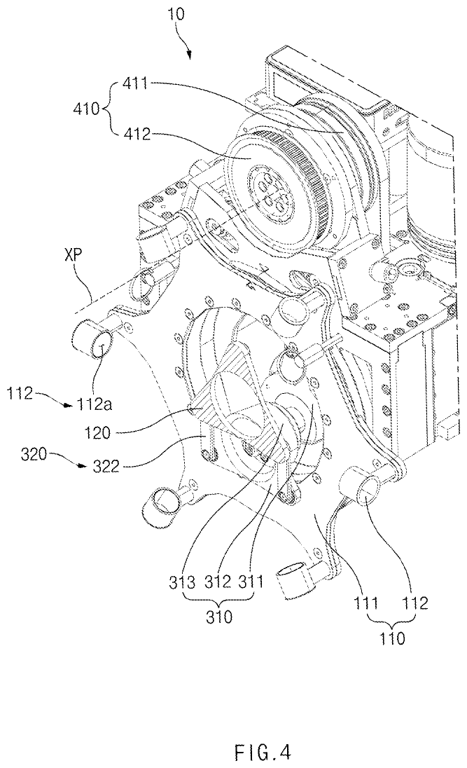

Referring back to FIG. 4, the main rotation body 111 may define an external appearance of the main rotation part 110. A hollow may be formed in the main rotation body 111. For example, the main rotation body 111 may have a ring shape that has a hole at a center thereof.

The rotation support part 112 may be connected to a periphery of the main rotation body 111 to be rotatable. For example, the rotation support part 112 may be rotated with respect to the main rotation body 111, about a rotation axis that passes a periphery of the main rotation body 111 and extends in an axial direction thereof. The rotation support part 112 may support the spoke 200. The rotation support part 112 may be connected to an outside of the main rotation body 111. An outward direction may be defined as a direction, in which the frame 20 faces the main rotation part 110, and an inward direction may be defined as an opposite direction to the outward direction. A guide hole 112a may be formed in the rotation support part 112.

Referring back to FIG. 4, the guide hole 112a may be a through-hole that is formed at a central portion of the rotation support part 112 in a direction that is perpendicular to an axial direction thereof. The spoke 200 may be inserted into the guide hole 112a. The guide hole 112a may guide movement of the spoke 200. For example, the guide hole 112a may guide translation of the spoke 200 with respect to the rotation support part 112. In other words, the spoke 200 may be slid with respect to the rotation support part 112 along the guide hole 112a.

Referring back to FIG. 1, a plurality of rotation support parts 112 may be provided. The plurality of rotation support parts 112 may be arranged to be spaced apart from each other along rotational directions C1 and C2. The rotational directions C1 and C2 may be defined as directions, in which the main rotation part 110 is rotated about the first rotation axis X1. The rotational directions C1 and C2 may be understood as a concept including the forward rotational direction C1 and the reverse rotational direction C2. The forward rotational direction C1 may be defined as a direction, in which the main rotation part 110 is rotated when the moving body 1 travels in the travel direction “D”. The reverse rotational direction C2 may be defined as an opposite direction to the forward rotational direction.

Furthermore, the plurality of rotation support parts 112 may include a first rotation support part and a second rotation support part. The first rotation support part and the second rotation support part may be defined as, among the plurality of rotation support parts 112, adjacent arbitrary two rotation support parts 112.

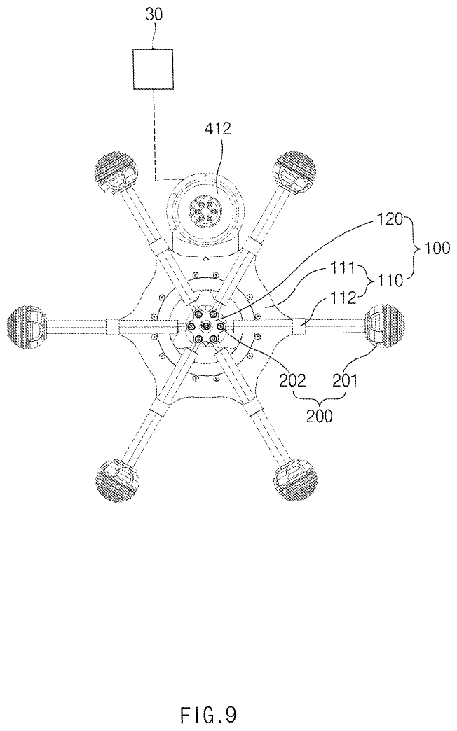

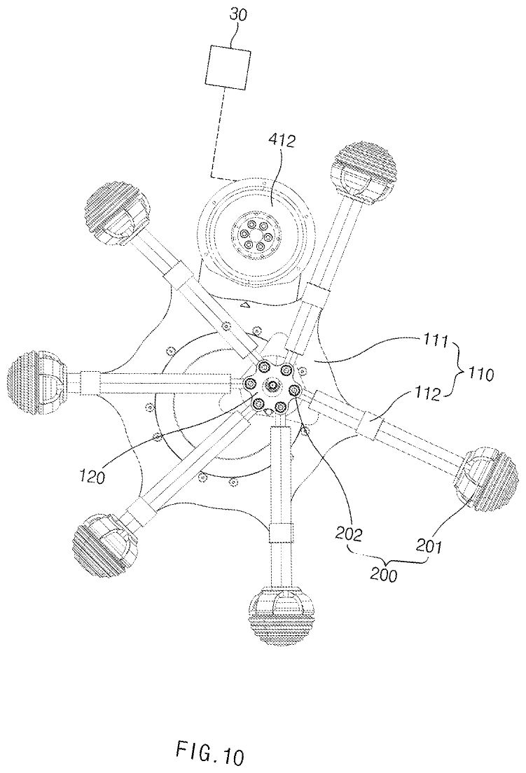

Referring back to FIGS. 9 and 10, when the variable rotation part 120 is moved relatively to the main rotation part 110 toward a side area, the first rotation support part and the second rotation support part may be rotated with respect to the main rotation body 111 such that an angle defined by a first line and a second line becomes larger. The first line may be defined as an imaginary line that passes through a center of the first rotation support part and extends along the guide hole of the first rotation support part. The second line may be defined as an imaginary line that passes through a center of the second rotation support part and extends along the guide hole of the second rotation support part. Furthermore, the side area may be defined as an area of a periphery of the main rotation body 111, which is formed between the first rotation support part and the second rotation support part. For example, the side area may be defined as an area that is disposed between the first rotation support part and the second rotation support part when the wheel assembly 10 is viewed along an axial direction thereof.

The variable rotation part 120 may be rotated about a second rotation axis X2. The second rotation axis X2, for example, may be defined as an imaginary line that passes through a center of the variable rotation part 120 and extends in parallel to an axial direction thereof. In other words, the second rotation axis X2 may be parallel to the first rotation axis X1. Furthermore, a variable angular velocity that is an angular velocity of the variable rotation part 120 may be the same as a main angular velocity that is an angular velocity of the main rotation part 110. A relationship between the variable angular velocity and the main angular velocity will be described in more detail in a description of the power transmitting part 300, which will be described below.

Furthermore, the variable rotation part 120 may be moved relatively to the main rotation part 110 in a relative movement direction that is a direction that is different from the axial direction. The relative movement direction, as an example, may be a direction that is perpendicular to the axial direction. The variable rotation part 120 may be moved relatively to the main rotation part 110 such that the second rotation axis X2 and the first rotation axis X1 overlap each other or are spaced apart from each other. The variable rotation part 120 may be moved relatively to the main rotation part 110 on the movement allowable area that crosses the first rotation axis X1.

The movement allowable area may be defined as an area that may pass through a center of the variable rotation part 120 when the variable rotation part 120 is moved relatively to the main rotation part 110. The movement allowable area may be surrounded by an imaginary circle, a center of which is a point, at which the movement allowable area and the first rotation axis X1 cross each other and a radius of which is a sum of a first driving distance and a second driving distance, which will be described below. The first driving distance may be defined as a spacing distance of a fixed center of rotation X3 and a variable center of rotation X4, which will be described below. Furthermore, the second driving distance may be defined as a spacing distance between the second rotation axis X2 and the variable center of rotation X4. Furthermore, a sum of the first driving distance and the second driving distance may be smaller than a spacing distance between a center of the main rotation body 111 and the rotation support part 112. In this way, because the sum of the first driving distance and the second driving distance is smaller than the spacing distance between the center of the main rotation body 111 and the rotation support part 112, interferences between the variable rotation part 120 and the rotation support part 112 may be prevented.

Furthermore, the variable rotation part 120 may be disposed on an outer side of the main rotation part 110. The variable rotation part 120 may cross an imaginary plane that passes through a center of the rotation support part 112 and is perpendicular to an axial direction thereof.

Referring to FIGS. 2 and 3, the spoke 200 may provide a ground surface repulsive force to the moving body 1. The moving body 1 may travel on the ground surface through the ground surface repulsive force received from the spoke 200. An outer end 201 of the spoke may contact the ground surface. The outer end 201 of the spoke, as an example, may have a ball shape. Furthermore, the outer end 201 of the spoke may be formed of a material (for example, a rubber material) that is prevented from being slid on the ground surface. Furthermore, an inner end 202 of the spoke may be connected to a periphery of the variable rotation part 120 to be rotatable.

Referring back to FIG. 10, the spoke 200 may be translated along the guide hole 112a when the variable rotation part 120 is moved relatively to the main rotation part 110. For example, when the variable rotation part 120 is moved relatively to the main rotation part 110 to become closer to the rotation support part 112, the outer end 201 of the spoke may be translated to become farther from the rotation support part 112. In other words, when the variable rotation part 120 is moved relatively to the main rotation part 110 to become closer to the rotation support part 112, a spacing distance between the outer end 201 of the spoke and the rotation support part 112 may become larger.

Furthermore, when the variable rotation part 120 is moved relatively to the main rotation part 110 to become farther from the rotation support part 112, the outer end 201 of the spoke may be translated to become closer to the rotation support part 112. In other words, when the variable rotation part 120 is moved relatively to the main rotation part 110 to become farther from the rotation support part 112, a spacing distance between the outer end 201 of the spoke and the rotation support part 112 may become smaller.

A plurality of spokes 200 may be provided. The plurality of spokes 200 may correspond to the plurality of rotation support parts 112, respectively. For example, when “n” rotation support part 112 (n>2) are provided, “n” spokes 200 may be provided to be inserted into the guide holes 112a of the “n” rotation support parts 112, respectively. The plurality of spokes 200 may be connected to a periphery of the variable rotation part 120 to be rotatable. For example, the plurality of spokes 200 may be arranged to be spaced apart from each other along a circumferential direction of the variable rotation part 120. The circumferential direction of the variable rotation part 120 may be defined as a direction, in which the variable rotation part 120 is rotated about the second rotation axis X2.

The plurality of spokes 200 may be laid in any one of a first posture and a second posture. Referring back to FIG. 9, the first posture may be defined as postures of the plurality of spokes 200 in a state, in which the first rotation axis X1 and the second rotation axis X2 overlap each other. Furthermore, referring back to FIG. 10, the second posture may be defined as postures of the plurality of spokes 200 in a state, in which the first rotation axis X1 and the second rotation axis X2 are spaced apart from each other.

Furthermore, referring back to FIG. 10, when the first rotation support part and the second rotation support part are rotated with respect to the main rotation body 111 such that an angle defined by the first line and the second line becomes larger, an outer end of a first spoke and an outer end of a second spoke may become farther away from each other. The first spoke may be, among the plurality of spokes 200, the spoke 200 corresponding to the first rotation support part. Furthermore, the second spoke may be, among the plurality of spokes 200, the spoke 200 corresponding to the second rotation support part.

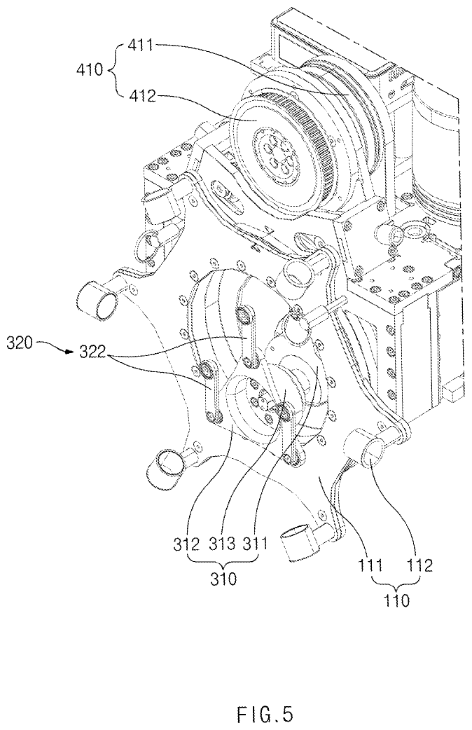

Referring back to FIGS. 5 to 8, the power transmitting part 300 may receive power from the main rotation part 110. The power transmitting part 300 may transmit the power received from the main rotation part 110 to the variable rotation part 120. Furthermore, the main rotation part 110, the variable rotation part 120, and the power transmitting part 300 may be connected to each other, as an example, through a Schmidt coupling scheme. For example, when the main rotation part 110 is rotated at a main angular velocity, the power transmitting part 300 may receive a rotational force from the main rotation part 110, and may be rotated at the same angular velocity as the main angular velocity. When the power transmitting part 300 is rotated, the variable rotation part 120 may receive a rotational force from the power transmitting part 300, and may be rotated at the same angular velocity as a rotational angular velocity of the power transmitting part 300. In other words, the rotational angular velocity and the variable angular velocity of the power transmitting part 300 may be the same. The power transmitting part 300 may include a medium rotation part 310 and a link part 320.

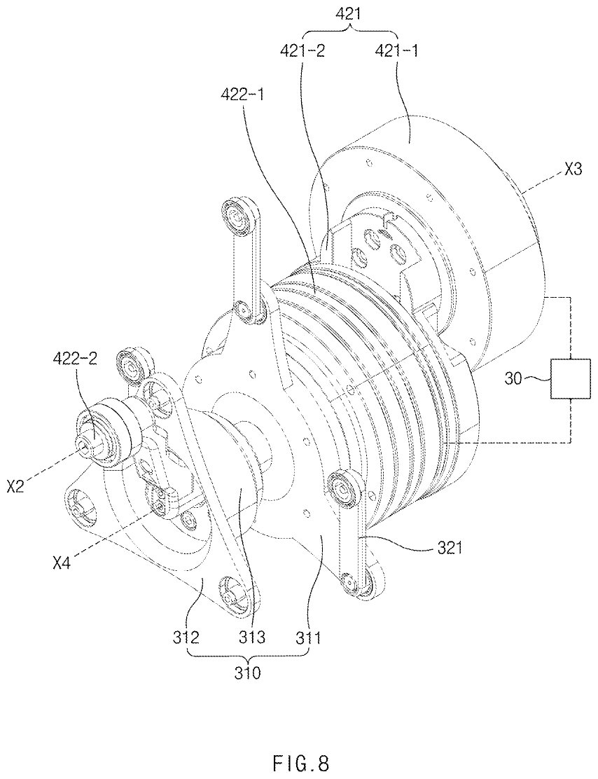

Referring back to FIG. 8, the medium rotation part 310 may receive the power from the main rotation part 110, and may be rotated about a medium rotation axis that passes through a center of the medium rotation part 310 and extends in parallel to an axial direction thereof. The medium rotation part 310 may include a first medium rotation part 311, a second medium rotation part 312, and a medium rotation body 313.

The first medium rotation part 311 may receive the power from a first link part 321 that will be described below to be rotated when the main rotation part 110 is rotated. The first medium rotation part 311 may transmit the power to the medium rotation body 313. The first medium rotation part 311 may be disposed on an inner side of the main rotation part 110.

The second medium rotation part 312 may receive the power from the medium rotation body 313 to be rotated when the medium rotation body 313 is rotated. The second medium rotation part 312 may transmit the power to the second link part 322 that will be described below. The second medium rotation part 312 may be disposed on an outer side of the main rotation part 110. For example, the main rotation part 110 may be disposed between the first medium rotation part 311 and the second medium rotation part 312. As a detailed example, the first medium rotation part 311, the main rotation part 110, and the second medium rotation part 312 may be sequentially disposed along an outward direction.

The medium rotation body 313 may extend along an axial direction thereof, between the first medium rotation part 311 and the second medium rotation part 312. For example, an inner end of the medium rotation body 313 may be connected to the first medium rotation part 311, and an outer end of the medium rotation body 313 may be connected to the second medium rotation part 312. The medium rotation body 313 may be disposed in a hollow of the main rotation body 111. For example, the medium rotation body 313 may be disposed to pass through the hollow of the main rotation body 111.

The link part 320 may include the first link part 321 and the second link part 322. The first link part 321 may transmit the power of the main rotation part 110 to the first medium rotation part 311. One end of the first link part 321 may be connected to an inner surface of the main rotation body 111 to be rotatable. Furthermore, an opposite end of the first link part 321 may be connected to an outer surface of the first medium rotation part 311 to be rotatable. A plurality of first link parts 321 may be provided.

Spacing distances of opposite ends of the plurality of first link parts 321 may be the same. Ends of the plurality of first link parts 321 may be disposed to be symmetrical to each other with respect to a center of the main rotation body 111. Furthermore, opposite ends of the plurality of first link parts 321 may be disposed to be symmetrical to each other with respect to the center of the first medium rotation part 311.

The second link part 322 may transmit the power of the second medium rotation part 312 to the variable rotation part 120. One end of the second link part 322 may be connected to an inner surface of the variable rotation part 120 to be rotatable. Furthermore, an opposite end of the second link part 322 may be connected to an outer surface of the second medium rotation part 312 to be rotatable. A plurality of second link parts 322 may be provided.

Spacing distances of opposite ends of the plurality of second link parts 322 may be the same. Ends of the plurality of second link parts 322 may be disposed to be symmetrical to each other with respect to a center of the variable rotation part 120. Furthermore, opposite ends of the plurality of second link parts 322 may be disposed to be symmetrical to each other with respect to the center of the second medium rotation part 312.

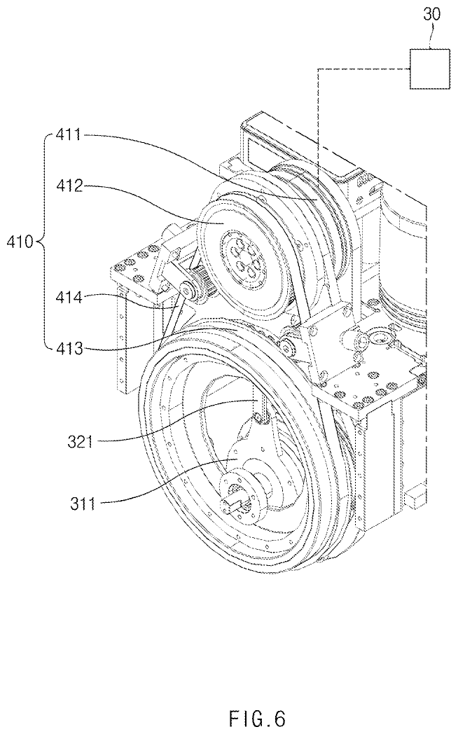

Referring to FIGS. 6 and 8, the driving part 400 may provide the power to the rotation part 100. The driving part 400 may include a first driving part 410 and a second driving part 420. The first driving part 410 may provide the power to the main rotation part 110. The first driving part 410 may include a main rotary motor 411, a driving pulley 412, a driven pulley 413, and a driving belt 414.

The main rotary motor 411 may rotate the driving pulley 412 about a pulley rotation axis XP. The pulley rotation axis XP may be defined as an imaginary line that passes a center of the driving pulley 412 and extends in an axial direction thereof. The pulley rotation axis XP may be spaced apart from the movement allowable area. For example, the pulley rotation axis XP may be disposed on an upper side of the movement allowable area. The main rotary motor 411 may be supported by the frame 20 such that a relative location thereof to the frame 20 is fixed.

The driving pulley 412 may be rotated about the pulley rotation axis XP. The driving pulley 412 may provide the power to the driving belt 414. The driving pulley 412, as an example, may have a disk shape having a hollow.

The driven pulley 413 may receive the power from the driving belt 414 to be rotated about the first rotation axis X1. The driven pulley 413 may be connected to the main rotation part 110. For example, the driven pulley 413 may be connected to an inner surface of the main rotation body 111. The driven pulley 413 may provide the power to the main rotation body 111. For example, the driven pulley 413 and the main rotation body 111 may be rotated together about the first rotation axis X1. The driven pulley 413, as an example, may have a disk shape having a hollow. For example, the driven pulley 413 may have a disk shape having a hollow, a radius of which is larger than the driving pulley 412.

The driving belt 414 may receive the power from the driving pulley 412. The driving belt 414 may transmit the power received from the driving pulley 412 to the driven pulley 413. The driving belt 414 may be disposed to surround the driving pulley 412 and the driven pulley 413.

The second driving part 420 may move the variable rotation part 120 relatively to the main rotation part 110. Furthermore, the first driving part 410 and the second driving part 420 may be driven independently. The second driving part 420 may include a fixed driving part 421 and a variable driving part 422.

The fixed driving part 421 may be supported by the frame such that a relative location thereof to the frame 20 is fixed. The fixed driving part 421 may be disposed on an inner side of the rotation part 100. The fixed driving part 421 may include a fixed motor 421-1 and a fixed driving arm 421-2.

The fixed motor 421-1 may provide power to the fixed driving arm 421-2. The fixed motor 421-1 may provide the fixed center of rotation X3. The fixed center of rotation X3 may be defined as an imaginary line that passes through the fixed driving arm 421-2 and extends in an axial direction thereof.

A relative location of the fixed center of rotation X3 to the first rotation axis X1 may be fixed. For example, the fixed center of rotation X3 may overlap the first rotation axis X1. Furthermore, the fixed center of rotation X3 and the second rotation axis X2 may be laid in any one of an overlapping state, in which they overlap each other, and a spacing state, in which they are spaced apart from each other.

Furthermore, the first rotation axis X1, the second rotation axis X2, and the fixed center of rotation X3 may overlap each other to be laid in a 3 axis overlapping state that defines one imaginary line. In other words, in the 3 axis overlapping state, the first rotation axis X1, the second rotation axis X2, and the fixed center of rotation X3 may be the same one axis. In this way, as the wheel assembly 10 is laid in the 3 axis overlapping state, a range of the movement allowable area may be maximized.

Furthermore, when the first rotation axis X1, the second rotation axis X2, and the fixed center of rotation X3 deviates from the 3 axis overlapping state, any one of the first rotation axis X1, the second rotation axis X2, and the fixed center of rotation X3 may be spaced apart from the others. The fixed motor 421-1 may rotate one end of the fixed driving arm 421-2 about the fixed center of rotation X3. Furthermore, the fixed motor 421-1 may be connected to the fixed driving arm 421-2. For example, an outer end of the fixed motor 421-1 may be connected to an opposite end to the one end of the fixed driving arm 421-2. An inner end of the fixed motor 421-1 may be fixed to the frame 20.

One end of the fixed driving arm 421-2 may be rotated about the fixed center of rotation X3. The one end of the fixed driving arm 421-2 may be connected to the variable driving part 422. For example, the one end of the fixed driving arm 421-2 may be rotated about the fixed center of rotation X3 together with the variable driving part 422. The opposite end of the fixed driving arm 421-2 may be connected to the fixed motor 421-1. Furthermore, the fixed center of rotation X3 may cross the opposite end of the fixed driving arm 421-2.

A relative location of the variable driving part 422 to the frame 20 may be changed. The variable driving part 422 may be supported by the fixed driving arm 421-2. The variable driving part 422 may be disposed on an outer side of the fixed driving part 421. For example, the variable driving part 422 may be connected to an outer side of the one end of the fixed driving arm 421-2. Furthermore, the fixed driving part 421 and the variable driving part 422 may be driven independently. The variable driving part 422 may include a variable motor 422-1 and a variable driving arm 422-2.

The variable motor 422-1 may provide power to the variable driving arm 422-2. The variable motor 422-1 may provide a variable center of rotation X4. The variable center of rotation X4 may be defined as an imaginary line that passes through the one end of the fixed driving arm 421-2 and extends in an axial direction thereof. The variable center of rotation X4 may be spaced apart from the fixed center of rotation X3. Furthermore, the variable center of rotation X4 may cross the movement allowable area.

The variable motor 422-1 may rotate an opposite end to the one end of the variable driving arm 422-2 about the variable center of rotation X4. One end of the variable driving arm 422-2, as an example, may mean an inner end of the variable driving arm 422-2. Furthermore, an opposite end of the variable driving arm 422-2, as an example, may mean an outer end of the variable driving arm 422-2.

An inner end of the variable motor 422-1, as an example, may be connected to the one end of the fixed driving arm 421-2. Furthermore, an outer end of the variable motor 422-1, as an example, may be connected to the one end of the variable driving arm 422-2.

In some cases, the fixed motor 421-1 and the variable motor 422-1 may be driven independently.

The one end of the variable driving arm 422-2 may be connected to the one end of the fixed driving arm 421-2. In some cases, the opposite end of the variable driving arm 422-2 may be connected to the variable rotation part 120 to be rotatable. For example, the opposite end of the variable driving arm 422-2 may not be rotated by the rotation of the variable rotation part 120. In other words, the variable rotation part 120 may be rotated with respect to the opposite end of the variable driving arm 422-2.

The opposite end of the variable driving arm 422-2 may be rotated about the variable center of rotation X4. The opposite end of the variable driving arm 422-2 and the second rotation axis X2 may cross each other. The second rotation axis X2 may pass through the opposite end of the variable driving arm 422-2 and a center of the variable rotation part 120. Furthermore, the second rotation axis X2 may be spaced apart from the variable center of rotation X4.

The frame 20 may support the plurality of wheel assemblies 10.

Hereinafter, a process of generating a rotational force in the variable rotation part 120 will be described.

When the main rotary motor 411 is driven, the driving pulley 412 may be rotated about the pulley rotation axis XP. When the driving pulley 412 is rotated, the driven pulley 413 may be rotated about the first rotation axis X1 through the driving belt 414. When the driven pulley 413 is rotated, the main rotation body 111 may be rotated about the first rotation axis X1 together with the driven pulley 413. When the main rotation body 111 is rotated, the first medium rotation part 311 may be rotated about the medium rotation axis through the first link part 321. When the first medium rotation part 311 is rotated, the medium rotation body 313 and the second medium rotation part 312 may be rotated about the medium rotation axis. When the second medium rotation part 312 is rotated, the variable rotation part 120 may be rotated about the second rotation axis X2 through the second link part 322.

Hereinafter, a process of generating power in the variable rotation part 120 such that the variable rotation part 120 is moved relatively to the main rotation part 110 will be described.

When the fixed motor 421-1 is driven, the one end of the fixed driving arm 421-2 may be rotated about the fixed center of rotation X3. When the one end of the fixed driving arm 421-2 is rotated, the variable motor 422-1 may be rotated about the fixed center of rotation X3 together with the fixed driving arm 421-2. When the variable motor 422-1 is rotated, the variable driving arm 422-2 may be rotated about the fixed center of rotation X3 together with the variable motor 422-1. In some cases, when the variable motor 422-1 is driven, the opposite end of the variable driving arm 422-2 may be rotated about the variable center of rotation X4. In other words, an angle, by which the opposite end of the variable driving arm 422-2 is rotated with respect to the main rotation part 110, may be defined as a sum of an angle, by which the variable motor 422-1 is rotated, and an angle, by which the opposite end of the variable driving arm 422-2 is rotated with respect to the variable motor 422-1. The variable rotation part 120 may be moved relatively to the main rotation part 110 together with the opposite end of the variable driving arm 422-2.

The controller 30 may control the driving part 400. The controller 30 may determine a main angular velocity by controlling the first driving part 410. Furthermore, the controller 30 may determine a location of the variable rotation part 120 on the movement allowable area by controlling the second driving part 420.

The controller 30 may input an acceleration command such that a travel speed of the moving body 1 becomes higher. For example, when the acceleration command is input to the controller 30, the driving part 400 may be controlled such that a spoke speed of a contact spoke becomes higher. The contact spoke may mean, the plurality of spokes 200, a spoke that contacts the ground surface. The spoke speed may be defined as a speed of the outer end 201 of the spoke relative to the first rotation axis X1 when the moving body 1 travels at the travel speed.

When an acceleration command is input to the controller such that the travel speed of the moving body 1 reaches a speed that is lower than a threshold travel speed, the controller may control the first driving part 410 to increase the main angular velocity and control the second driving part 420 such that the plurality of spokes 200 is laid in the first posture. The threshold travel speed may be defined as a travel speed of the moving body 1 when the plurality of spokes 200 is laid in the first posture and the main angular velocity is maximal.

Furthermore, when an acceleration command is input to the controller 30 such that the travel speed of the moving body 1 reaches a speed that is higher than the threshold travel speed, the controller 30 may control the first driving part 410 such that the main angular velocity is maximal, and may perform an angle control to control the second driving part such that the posture of the plurality of spokes 200 is changed from the first posture to the second posture.

When the controller 30 performs an angle control, the second driving part 420 may move the variable rotation part such that an angle defined by the contact spoke and the adjacent spoke becomes larger. The adjacent spoke may be defined as, among the plurality of spokes 200, the spoke 200 that is adjacent to the contact spoke and is disposed on a side that is closer to the reverse rotational direction C2 than the contact spoke. For example, when the controller 30 performs an angle control, the second driving part 420 may move the variable rotation part 120 toward an included area of the main rotation part 110 that is an area formed between the control spoke and the adjacent spoke. The included area may be defined as an area of a periphery area of the main rotation part 110, which is disposed between the contact spoke and the adjacent spoke.

The controller 30 may be implemented by a processor that is electrically connected to the driving part 400 and has a function of decoding and executing a command based on information that is input in advance.

In some cases, according to another implementation of the present disclosure, when an acceleration command is input to the controller 30 such that the travel speed of the moving body 1 reaches a target travel speed, the controller 30 may determine a plurality of target spoke speeds. The plurality of target spoke speeds may be defined as speeds of outer ends 201 of the plurality of spokes.

The controller 30 may calculate the main angular velocity, the first rotation angular velocity, and the second rotation angular velocity based on the plurality of determined target spoke speeds. The first rotation angular velocity may be defined as a rotation angular velocity of the one end of the fixed driving arm 421-2 when the one end of the fixed driving arm 421-2 is rotated about the fixed center of rotation X3. The second rotation angular velocity may be defined as a rotation angular velocity of the opposite end of the variable driving arm 422-2 when the opposite end of the variable driving arm 422-2 is rotated about the variable center of rotation X4.

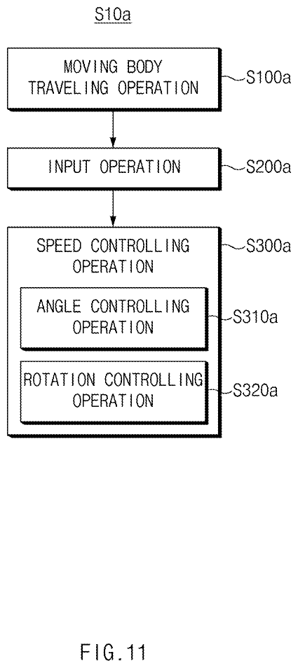

Hereinafter, referring to FIG. 11, a method S10a for controlling the wheel assembly according to an implementation of the present disclosure will be described.

A method S100a for controlling the wheel assembly may include a moving body traveling operation S100a, an input operation S200a, and a speed controlling operation S300a.

In the moving body traveling operation S100a, the moving body 1 may travel on the ground surface at a travel speed.

In the input operation S200a, an acceleration command may be input to the controller 30 such that the travel speed of the moving body 1 becomes higher. For example, in the input operation S200a, an acceleration command may be input such that the travel speed of the moving body 1 becomes higher or lower than a threshold travel speed.

In the speed controlling operation S300a, a spoke speed of, among the plurality of spokes 200, a spoke that contacts the ground surface may become higher when an acceleration command is input to the controller 30 in the input operation S200a. The speed controlling operation S300a may include an angle controlling operation S310a and a rotation controlling operation S320a.

In the angle controlling operation S310a, postures of the plurality of spokes 200 may be controlled. When an acceleration command is input to the controller 30 such that the travel speed of the moving body 1 reaches a speed that is higher than the threshold travel speed, the angle controlling operation S310a may be performed. In the angle controlling operation S310a, an angle defined by the contact spoke and the adjacent spoke may become larger. When the angle controlling operation S310a is performed, the wheel assembly 10 may show the same effects as if a stride of a person become wider as the angle defined by the contact spoke and the adjacent spoke becomes larger. Furthermore, when the angle controlling operation S310a is performed, a posture of the plurality of spokes 200 may be changed from the first posture to the second posture.

In the rotation controlling operation S320a, the main angular velocity may be controlled. For example, when an acceleration command is input to the controller 30 such that the travel speed of the moving body 1 reaches a speed that is lower than the threshold travel speed, the main angular velocity may become higher such that the main angular velocity reaches an angular velocity that is lower than a maximum main angular velocity in the rotation controlling operation S320a. Furthermore, when an acceleration command is input to the controller 30 such that the travel speed of the moving body 1 reaches a speed that is higher than the threshold travel speed, the main angular velocity may become maximal in the rotation controlling operation S320a.

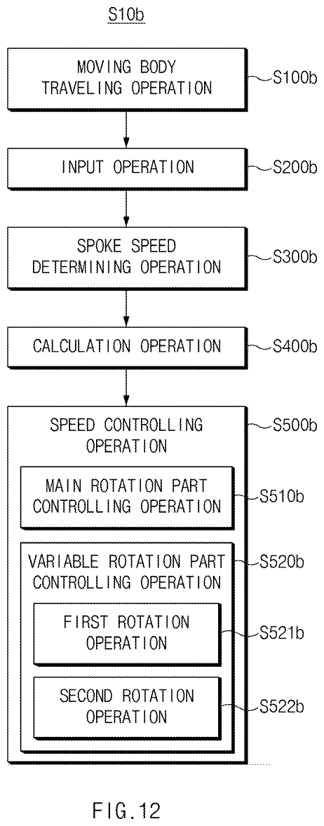

Hereinafter, referring to FIG. 12, a method S10b for controlling the wheel assembly according to another implementation of the present disclosure will be described.

The method S10b for controlling the wheel assembly may include a moving body traveling operation S100b, an input operation S200b, a spoke speed determining operation S300b, a calculation operation S400b, and a speed controlling operation S500b. The description of the moving body traveling operation S100a according to an implementation of the present disclosure is applied to a description of the moving body traveling operation S100b.

In the input operation S200b, an acceleration command (hereinafter, a target acceleration command) is input to the controller 30 such that the travel speed of the moving body 1 reaches the target travel speed.

In the spoke speed determining operation S300b, when the target acceleration command is input to the controller 30, a plurality of target spoke speeds that are spoke speeds of the outer ends 201 of the plurality of spokes may be determined.

In the calculation operation S400b, a main angular velocity, a first rotation angular velocity, and a second rotation angular velocity may be calculated based on the plurality of determined target spoke speeds.

In the speed controlling operation S500b, the main rotation part 110 is rotated based on the main angular velocity, the first rotation angular velocity, and the second rotation angular velocity that are calculated, and the variable rotation part 120 may be moved relatively to the main rotation part 110. The speed controlling operation S500b may include a main rotation part controlling operation S510b and a variable rotation part controlling operation S520b.

In the main rotation part controlling operation S510b, the main rotation part 110 may be rotated at the calculated main angular velocity.

In the variable rotation part controlling operation S520b, the variable rotation part 120 may be moved relatively to the main rotation part 110 based on the first rotation angular velocity and the second rotation angular velocity, which are calculated. The variable rotation part controlling operation S520b may be performed at the same time as or a different time from the main rotation part controlling operation S510b. The variable rotation part controlling operation S520b may include a first rotation operation S521b and a second rotation operation S522b.

In the first rotation operation S521b, the one end of the fixed driving arm 421-2 may be rotated about the fixed center of rotation X3 at the calculated first rotation angular velocity. Furthermore, in the second rotation operation S522b, the opposite end of the variable driving arm 422-2 may be rotated about the variable center of rotation X4 at the calculated second rotation angular velocity. The first rotation operation S521b and the second rotation operation S522b may be performed at the same time or may be performed at different times.

According to the wheel assembly according to the present disclosure, various postures may be implemented by securing a sufficient movement range of the variable rotation part.

Although it may have been described above that elements of the present disclosure are coupled to one another, the present disclosure is not essentially limited to such implementations. That is, without departing from the purpose of the present disclosure, all the elements may be selectively coupled into one or more elements to be operated.

The above description is a simple exemplification of the technical spirits of the present disclosure, and the present disclosure may be variously corrected and modified by those skilled in the art to which the present disclosure pertains without departing from the essential features of the present disclosure. Accordingly, the implementations disclosed in the present disclosure is not provided to limit the technical spirits of the present disclosure but provided to describe the present disclosure, and the scope of the technical spirits of the present disclosure is not limited by the implementations. Accordingly, the technical scope of the present disclosure should be construed by the attached claims, and all the technical spirits within the equivalent ranges fall within the scope of the present disclosure.

What is claimed is:

1. A wheel assembly comprising:
a main rotation part configured to be rotated about a first rotation axis;
a power transmitting part configured to receive power from the main rotation part; and
a variable rotation part configured to (i) receive a rotational force from the power transmitting part to be rotated about a second rotation axis when the main rotation part is rotated, and (ii) be moved relative to the main rotation part such that the first rotation axis and the second rotation axis overlap each other or are spaced apart from each other.

2. The wheel assembly of claim 1, wherein the power transmitting part includes:
a first link part having a first end that is rotatably connected to the main rotation part, the first link part being configured to receive the power of the main rotation part based on the main rotation part being rotated; and
a first medium rotation part rotatably connected to a second end of the first link part opposite the first end, the first medium rotation part being configured (i) to receive the power from the first link part (ii) to transmit the received power to the variable rotation part to thereby rotate the variable rotation part.

3. The wheel assembly of claim 2, wherein the power transmitting part further includes:
a second medium rotation part configured to receive the power from the first medium rotation part; and
a second link part having (i) a first end that is connected to the second medium rotation part to be rotatable and (ii) a second end opposite the first end that is connected to the variable rotation part to be rotatable, and
wherein the second link part is configured to receive the power of the second medium rotation part and transmit the received power to the variable rotation part to thereby rotate the variable rotation part.

4. The wheel assembly of claim 3, wherein, when viewed along a direction that is perpendicular to the first rotation axis, the main rotation part is disposed between the first medium rotation part and the second medium rotation part.

5. The wheel assembly of claim 1, further comprising:
a spoke having an inner end that is rotatably connected to the variable rotation part and an outer end that is configured to contact a ground surface.

6. The wheel assembly of claim 5, wherein the main rotation part includes a main rotation body, and a rotation support part that is rotatably connected to a periphery of the main rotation body to support the spoke, and
wherein the spoke is configured, based on the variable rotation part being moved relative to the main rotation part, to be translated with respect to the rotation support part, and
wherein an inner end of the spoke is rotatably connected to a periphery of the variable rotation part.

7. The wheel assembly of claim 6, wherein the outer end of the spoke is configured to:
be translated to become farther from the rotation support part when being moved relative to the main rotation part such that the variable rotation part becomes closer to the rotation support part, and
be translated to become closer to the rotation support part when being moved relative to the main rotation part such that the variable rotation part becomes farther from the rotation support part.

8. The wheel assembly of claim 6, wherein a plurality of rotation support parts are arranged to be spaced apart from each other along a rotational direction of the main rotation part, and
wherein a plurality of spokes are provided to correspond to the rotation support parts, respectively.

9. The wheel assembly of claim 8, wherein the spoke is configured to be inserted into the rotation support part, and a guide hole that is configured to guide translations of the spoke with respect to the rotation support part is defined therein.

10. The wheel assembly of claim 9, wherein, (i) based on adjacent arbitrary two rotation support parts among the plurality of rotation support parts being defined as a first rotation support part and a second rotation support part, respectively, and (ii) based on the variable rotation part being moved relative to the main rotation part toward an area of the periphery of the main rotation body, which is formed between the first rotation support part and the second rotation support part, the first rotation support part and the second rotation support part are rotated with respect to the main rotation body such that an angle defined by an imaginary line that extends along a guide hole of the first rotation support part and an imaginary line that extends along a guide hole of the second rotation support part becomes larger.

11. The wheel assembly of claim 1, further comprising:
a first driving part configured to rotate the main rotation part; and
a second driving part configured to move the variable rotation part relative to the main rotation part,
wherein the first driving part and the second driving part are configured to be driven independently.

12. The wheel assembly of claim 11, wherein the first driving part includes:
a main rotary motor configured to provide a pulley rotation axis that is spaced apart from the first rotation axis;
a driving pulley configured to be rotated about the pulley rotation axis based on the main rotary motor being driven; and
a driven pulley configured to receive a rotational force from the driving pulley to be rotated about the first rotation axis together with the main rotation part based on the driving pulley being rotated.

13. The wheel assembly of claim 12, wherein the pulley rotation axis is spaced apart from the second rotation axis.

14. The wheel assembly of claim 11, wherein the second driving part includes:
a fixed driving part including a fixed driving arm, one end of which is rotated about a fixed center of rotation, of which a relative location with respect to the first rotation axis is fixed; and
a variable driving part including a variable driving arm, one end of which is connected to the fixed driving arm and an opposite end of which is connected to the variable rotation part, and configured to be rotated about a variable center of rotation that passes through the fixed driving arm and is spaced apart from the fixed center of rotation.

15. The wheel assembly of claim 14, wherein the second rotation axis passes through the opposite end of the variable driving part and extends along a direction that is parallel to the fixed center of rotation, and
wherein the second rotation axis and the fixed center of rotation are laid in any one of an overlapping state, in which they overlap each other, and a spacing state, in which they are spaced apart from each other.

16. The wheel assembly of claim 15, wherein the first rotation axis, the second rotation axis, and the fixed center of rotation overlap each other to define one imaginary line.

17. The wheel assembly of claim 15, wherein the fixed driving part further includes a fixed motor configured to provide the fixed center of rotation, and connected to the fixed driving arm to rotate one end of the fixed driving arm about the fixed center of rotation, and
wherein the variable driving part further includes a variable motor configured to provide the variable center of rotation, connected to the one end of the fixed driving arm, and connected to the variable driving arm to rotate an opposite end of the variable driving arm about the variable center of rotation.

18. The wheel assembly of claim 17, wherein the fixed motor and the variable motor are configured to be driven independently.

19. The wheel assembly of claim 14, wherein the variable rotation part is configured to be moved relative to the main rotation part in a movement allowable area that is an area that crosses the first rotation axis, and
wherein the movement allowable area is surrounded by an imaginary circle, a center of which is a point, at which the movement allowable area and the first rotation axis cross each other and a radius of which is a sum of a first driving distance that is a spacing distance between the fixed center of rotation and the variable center of rotation and a second driving distance that is a spacing distance between the second rotation axis and the variable center of rotation.
